(19) United States
(12) Patent Application Publication
(10) Pub. No.: US 2026/0336817 A1
(43) Pub. Date: Oct. 29, 2026

(54) LOCKING SYSTEM FOR A COWL OF AN AIRCRAFT ENGINE NACELLE

(71) Applicant: Airbus Operations SAS, TOULOUSE (FR)

(72) Inventors: Simon VANDERBAUWEDE, TOULOUSE (FR); Nicolas CHARTON, TOULOUSE (FR); Quentin GRANGE, TOULOUSE (FR)

(21) Appl. No.: 19/659,393

(22) Filed: Apr. 27, 2026

(30) Foreign Application Priority Data
Apr. 29, 2025 (FR) FR2504517

(51) Int. Cl. B64D 29/06

(52) U.S. Cl. CPC B64D 29/06

(57) ABSTRACT

A locking system for two cowls of a nacelle, which has, for each cowl, a hook that is able to move in rotation between a locked position in which it cooperates with a roller of the cowl and an unlocked position, a handle link that is able to move in rotation between a closed position and an open position, a handle secured to the handle link, and for each hook, a spring-loaded link operating in traction and mounted between the handle link and the hook and arranged so as to move the hook from the locked position to the unlocked position when the handle link passes from the closed position to the open position and vice versa.

### CROSS-REFERENCES TO RELATED APPLICATIONS

This application claims the benefit of French Patent Application Number FR2504517, filed on Apr. 29, 2025, the entire disclosure of which is incorporated herein by way of reference.

### FIELD OF THE INVENTION

The present invention relates to a system for locking a cowl of an aircraft engine nacelle, to an aircraft engine nacelle comprising such a locking system, and to an aircraft comprising such a nacelle.

### BACKGROUND OF THE INVENTION

A nacelle surrounds the aircraft engine and comprises cowls that form an aerodynamic surface. During maintenance operations, it is necessary to open or remove the cowls to allow a technician to perform work on the elements that are under the cowls.

Each cowl is mounted so as to articulate on a plurality of hinges arranged at the upper portion (generally at the 12 o'clock position) and is locked by a locking system at the lower portion (generally at the 6 o'clock position). The locking systems currently implemented rely on a hook that is mounted so as to articulate on one of the cowls and is locked at a roller secured to the other cowl. The present invention proposes an alternative that makes it possible to ensure redundancy and reinforce security.

### SUMMARY OF THE INVENTION

One object of the present invention is to propose a system for locking a cowl of a nacelle of an aircraft engine that provides improved force resistance.

To that end, a locking system for two cowls of a nacelle of an aircraft is proposed, said locking system comprising:
a structure,
for each cowl, a hook mounted so as to be able to move in rotation on the structure between a locked position in which it is intended to cooperate with a roller of said cowl in order to immobilize said cowl and an unlocked position in which it does not cooperate with the roller in order to release said cowl,
a handle link mounted so as to be able to move in rotation on the structure between a closed position and an open position,
a handle secured to the handle link, and
for each hook, a spring-loaded link operating in traction and having a first end mounted so as to articulate on the handle link and a second end mounted so as to articulate on the hook and arranged so as to move the associated hook from the locked position to the unlocked position when the handle link passes from the closed position to the open position and vice versa.

With such an arrangement, there are two hooks that are tensioned and that each interact with one of the cowls, specifically by means of a single handle.

Advantageously, the connection between each hook and the second end of the associated spring-loaded link is achieved by means of a first link mounted so as to be able to move in rotation on the structure and a second link mounted so as to articulate, on the one hand, with the hook and, on the other hand, with the first link, and wherein the first link is mounted so as to articulate with the second end of the spring-loaded link.

Advantageously, the locking system comprises, for each first link, a first stop that is secured to the structure and against which said first link is in abutment when the associated hook is in the locked position.

Advantageously, the locking system comprises a second stop that is secured to the structure and against which the handle link is in abutment when the handle link is in the closed position.

Advantageously, the locking system comprises a detection lever mounted so as to be able to move in rotation and, for each hook, a rod having a first end mounted so as to articulate with said hook and a second end mounted so as to articulate with the detection lever, and said detection lever is able to move between a retracted position in which it does not prevent the handle link from passing towards its closed position and an extended position in which it prevents the handle link from passing towards its closed position.

The invention also proposes a nacelle of an engine of an aircraft comprising two cowls and at least one locking system according to one of the preceding variants, wherein each cowl is mounted so as to articulate at an upper portion and has, for each locking system, a roller arranged at a lower portion and designed to cooperate with the associated hook in the locked position.

Advantageously, the nacelle comprises:
a plurality of locking systems, wherein the locking systems are distributed along the cowls, wherein only one of the handle links is equipped with a handle, and
a shaft coaxial with an axis of rotation common to all of the handle links and secured to all of the handle links.

The invention also proposes an aircraft having at least one nacelle according to one of the preceding variants.

### BRIEF DESCRIPTION OF THE DRAWINGS

The features of the invention that are mentioned above, along with others, will become more clearly apparent upon reading the following description of one exemplary embodiment, said description being given with reference to the appended drawings, in which:

FIG. 1 is a side view of an aircraft equipped with a nacelle equipped with a locking system according to the invention,

FIG. 2 is a schematic representation, in a front view, of a locking system according to the invention in the locked position,

FIG. 3 is a schematic representation, in a front view, of the locking system in FIG. 2 in the unlocked position, and

FIG. 4 is a perspective view of the locking system in FIG. 2 in the unlocked position.

### DETAILED DESCRIPTION OF THE PREFERRED EMBODIMENTS

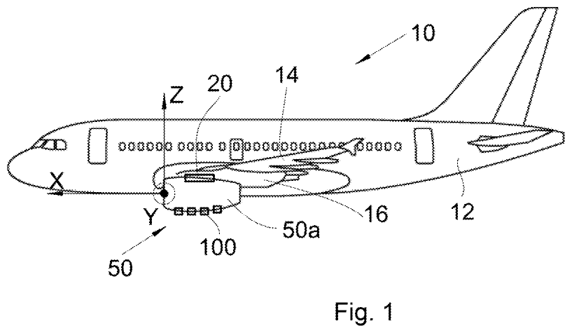

FIG. 1 shows an aircraft 10 that comprises a fuselage 12 to either side of which a wing 14 is fastened and each wing 14 bears at least one nacelle 50 in which an engine is arranged. The nacelle 50 is fastened to the wing 14 by a pylon 16.

In the following description, and by convention, X denotes the longitudinal axis of the nacelle 50, which is parallel to the longitudinal axis of the aircraft 10, with positive orientation in the direction of forward movement of the aircraft 10, Y denotes the transverse axis, which is horizontal when the aircraft 10 is on the ground, and Z denotes the vertical axis, which is vertical when the aircraft 10 is on the ground, these three axes X, Y and Z being mutually orthogonal.

The nacelle 50 comprises two cowls 50a-b, which are arranged on either side of a vertical median plane XZ. Each cowl 50a-b is mounted so as to articulate at an upper portion (generally at the 12 o'clock position) of said cowl 50a-b on the pylon 16 or on a structure of the engine by means of hinges 20.

The nacelle 50 also comprises at least one locking system 100 according to the invention. In the embodiment of the invention shown in FIG. 1, there are a plurality of locking systems 100 and the locking systems 100 are distributed along the cowls 50a-b, and more particularly along the lower edges of the cowls 50a-b.

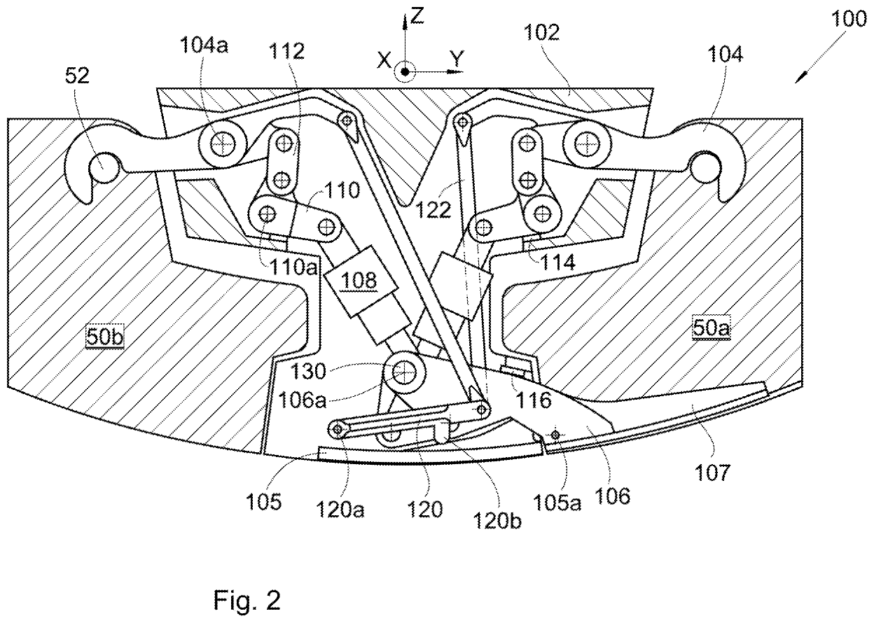

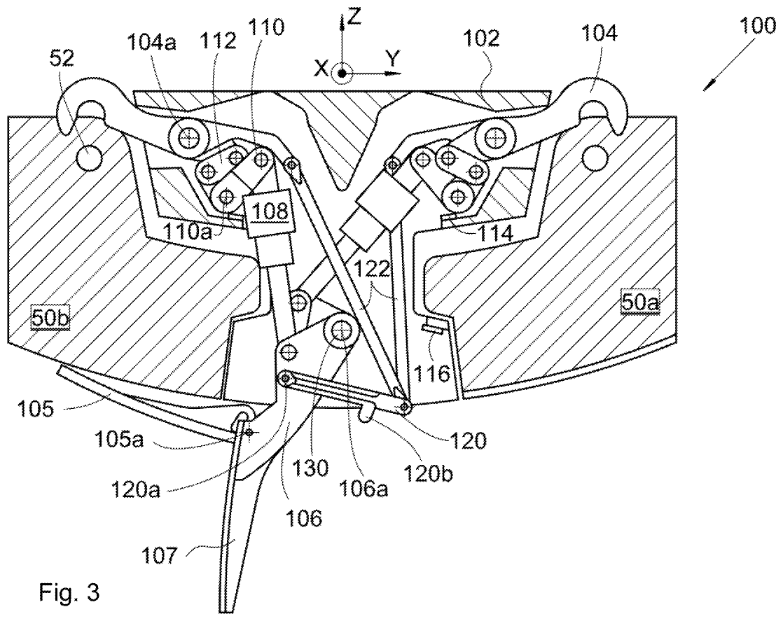

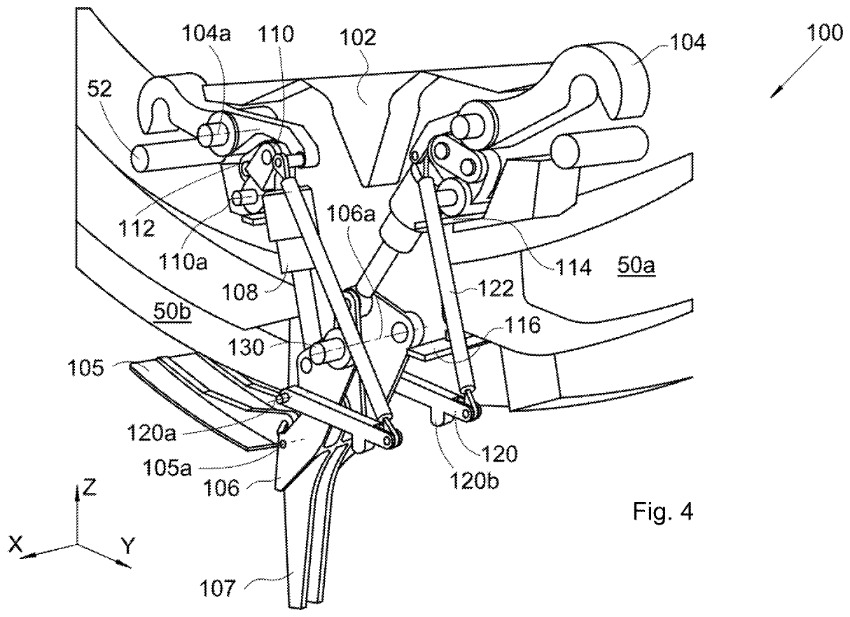

FIG. 2 shows the locking system 100 according to the invention in a front view and in the locked position and FIG. 3 and FIG. 4 show the same locking system 100 in the unlocked position.

Each cowl 50a-b has a roller 52 arranged at a lower portion of said cowl 50a-b (generally at the 6 o'clock position). If there are a plurality of locking systems 100, each cowl 50a-b has one roller 52 for each of said locking systems 100.

The locking system 100 comprises a structure 102, which may be part of the engine or of the nacelle 50.

The locking system 100 also comprises, for each cowl 50a-b, a hook 104 mounted so as to be able to move in rotation on the structure 102 between a locked position (FIG. 2) in which it cooperates with the roller 52 of the corresponding cowl 50a-b in order to immobilize said cowl 50a-b and an unlocked position (FIG. 3) in which it does not cooperate with the roller 52 in order to release said cowl 50a-b, which can then move around the hinges 20.

The axis of rotation 104a of each hook 104 is in this case parallel to the longitudinal axis X.

The locking system 100 also comprises a handle link 106 mounted so as to be able to move in rotation on the structure 102 between a closed position (FIG. 2) and an open position (FIG. 3). The axis of rotation 106a of the handle link 106 is in this case parallel to the longitudinal axis X.

The present invention provides a system for transmitting the movement between each hook 104 and the same handle link 106, respectively. Each transmission system comprises two bracing devices in series, making it possible, if one fails, for the other to take over to ensure the movement of the hook 104. The two transmission systems are connected to the same axis at the handle link 106: in the embodiment illustrated, they are connected to the axis on either side of the handle link 106. In addition, a system for detecting failure of each movement transmission system is also provided in parallel with the latter. This detection system provides a direct mechanical connection between the hook 104 and the structure 102. The purpose of this mechanical system is not to ensure the transmission of movement (which is ensured by the first path) but to warn an operator if the transmission system fails. Its purpose is to provide a mechanical indication that the movement transmission system has failed and makes it possible to mechanically prevent in this case the closure of the relevant cowl 50a-b.

The locking system 100 also comprises a handle 107, which is secured to the handle link 106 and can be gripped by a technician from the outside of the nacelle 50. The movement of the handle 107 by the technician will cause the handle link 106 to move in rotation. In the closed position, the handle 107 retracts into one of the cowls 50a for aerodynamic reasons.

For each hook 104, the locking system 100 comprises a spring-loaded link 108 that operates in traction. The spring-loaded link 108 has a first end mounted so as to articulate on the handle link 106 and a second end mounted so as to articulate indirectly on the hook 104. The second end is in this case secured to the sleeve of the spring-loaded link 108 and the first end is in this case secured to the rod of the spring-loaded link 108. The rod is able to move in translation relative to the sleeve, i.e., it can extend from the sleeve to a greater or lesser extent depending on the forces exerted between the two ends. The spring-loaded link 108 also has a traction spring that is mounted in the sleeve, and mounted between the sleeve and the rod in order to pull on the rod and cause it to retract into the sleeve.

Each spring-loaded link 108 is arranged so as to move the associated hook 104 from the locked position to the unlocked position when the handle link 106 passes from the closed position to the open position and vice versa under the action of the handle 107.

The articulation associated with each end of the spring-loaded links 108 is at least one rotation, the axis of which is in this case parallel to the longitudinal axis X.

With such an arrangement, each cowl 50a-b is held in the locked position by at least one hook 104, each of which is associated with a roller 52 and each hook 104 is subjected to the traction of a spring-loaded link 108 in order to structurally reinforce the cowls 50a-b.

In the embodiment of the invention shown here, the connection between each hook 104 and the second end of the associated spring-loaded link 108 is achieved by means of a combination of a first link 110 and a second link 112.

The first link 110 is mounted so as to be able to move in rotation on the structure 102, in this case about an axis of rotation 110a parallel to the longitudinal axis X.

The second link 112 is mounted so as to articulate, on the one hand, at a first end with the hook 104 and, on the other hand, at a second end with the first link 110 while the first link 110 is mounted so as to articulate with the second end of the spring-loaded link 108.

The articulation associated with each end of the second links 112 and with the first link 110 is at least one rotation, the axis of which is in this case parallel to the longitudinal axis X.

In order to stop the hooks 104 when they are in the locked position, the locking system 100 comprises, for each first link 110, a first stop 114 that is secured to the structure 102 and against which said first link 110 is in abutment when the associated hook 104 is in the locked position. The first link 110, the second link 112 and the stop 114 form the first bracing device.

In the same way, in order to stop the handle link 106 when it is in the closed position, the locking system 100 comprises a second stop 116 that is secured to the structure 102 and against which the handle link 106 is in abutment when it is in the closed position. The handle link 106 and the spring-loaded link 108 with the stop 116 form the second bracing device.

In order to prevent the handle link 106 or the handle 107 from being moved towards the closed position when at least one of the hooks 104 is not in the locked position, the locking system 100 has a suitable failure detection system, as seen above.

The detection system thus comprises, for each hook 104, a detection lever 120 and a rod 122.

The detection lever 120 is mounted so as to be able to move in rotation about an axis of rotation 120a, which is connected to the structure 102 and is in this case parallel to the longitudinal axis X, between a retracted position in which it does not prevent the handle link 106 from passing towards its closed position and an extended position. In the embodiment of the invention shown here, the detection lever 120 has a protuberance 120b that projects towards the outside of the nacelle 50 in the extended position. Thus, if everything is in order when the handle link 106 is in the closed position, it is flush with the cowl 50a-b and the operator thus knows that the cowl 50a-b is properly closed. When the handle link 106 is in the open position, the protuberance is visible and the operator knows that the hook 104 is released. On the other hand, if the transmission system has failed, because the hook 104 is directly connected to the structure by the rod 122 and the detection lever 120, if the hook 104 does not move due to the failure, the same goes for the detection lever 120, thereby making it possible to detect a failure.

Each rod 122 has a first end mounted so as to articulate with the associated hook 104 and a second end mounted so as to articulate with the detection lever 120. The articulation associated with each end of the rods 122 is at least one rotation, the axis of which is in this case parallel to the longitudinal axis X.

When the two hooks 104 move from the locked position to the unlocked position, they push the detection lever 120 back, which passes into the extended position and when the two hooks 104 move from the unlocked position to the locked position, they pull on the detection lever 120, which retracts towards the retracted position.

If at least one of the hooks 104 does not pass into the locked position, the detection lever 120 remains in the extended position and it is impossible for the handle link 106 to move towards the closed position.

In the embodiment of the invention shown here, in order to assist in the manipulation of the handle 107, the locking system 100 comprises a sub-handle 105, which is mounted so as to be able to move in rotation on the handle link 106 about an axis of rotation 105a. The sub-handle 105 is able to move between a deployed position and a stowed position. In the stowed position, the sub-handle 105 extends the handle 107 to form an aerodynamic surface by closing the space between the cowls 50a-b. In the deployed position, the sub-handle 105 extends towards the outside of the nacelle 50.

In the embodiment of the invention shown in FIG. 1, there are a plurality of locking systems 100 and according to a first variant, each of them may have a handle 107 and in this case, each handle 107 has to be maneuvered in order to open and close the cowls 50a-b.

According to another variant, it is possible to have a handle 107 that is common to all of the locking systems 100, and thus only one of the handle links 106 is equipped with a handle 107.

The axes of rotation 106a of all of the handle links 106 are coaxial and the nacelle 50 then comprises a shaft 130 coaxial with the axis of rotation 106a and secured to all of the handle links 106.

Thus, the movement of the handle 107 will cause all of the handle links 106 to move.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A locking system for two cowls of a nacelle of an aircraft, the locking system comprising:
a structure;
for each cowl of the two cowls, a hook mounted to move in rotation on the structure between a locked position in which the hook cooperates with a roller of said cowl in order to immobilize said cowl and an unlocked position in which the hook does not cooperate with the roller in order to release said cowl;
a handle link mounted to move in rotation on the structure between a closed position and an open position;
a handle secured to the handle link; and
for each hook, a spring-loaded link operating in traction and having a first end mounted so as to articulate on the handle link and a second end mounted so as to articulate on said hook and arranged to move said hook from the locked position to the unlocked position when the handle link passes from the closed position to the open position and arranged to move said hook from the unlocked position to the locked position when the handle link passes from the open position to the closed position.

2. The locking system according to claim 1, wherein a connection between each hook and the second end of one of the spring-loaded links comprises a first link mounted to move in rotation on the structure and a second link mounted so as to articulate with the hook and with the first link, and
wherein the first link is mounted so as to articulate with the second end of the one of the spring-loaded links.

3. The locking system according to claim 2, further comprising:
for each first link, a first stop secured to the structure and against which said first link is in abutment when said hook is in the locked position.

4. The locking system according to claim 1, further comprising:
a second stop secured to the structure and against which the handle link is in abutment when the handle link is in the closed position.

5. The locking system according to claim 1, further comprising:
a detection lever mounted to move in rotation; and,
for each hook, a rod having a first end mounted to articulate with said hook and a second end mounted to articulate with the detection lever,
wherein the detection lever is configured to move between a retracted position in which the detection lever does not prevent the handle link from passing towards the closed position and an extended position in which the detection lever prevents the handle link from passing towards the closed position.

6. A nacelle of an engine of an aircraft comprising:
two cowls; and
at least one locking system according to claim 1,
wherein each of the two cowls is mounted so as to articulate at an upper portion and has, for each of the at least one locking system, a roller arranged at a lower portion and configured to cooperate with one of the hooks in the locked position.

7. The nacelle according to claim 6, wherein the at least one locking system comprises a plurality of locking systems,
wherein the plurality of locking systems are distributed along the cowls,
wherein only one of the handle links is equipped with a handle, and
wherein a shaft is provided which is coaxial with an axis of rotation common to all handle links and secured to all handle links.

8. An aircraft comprising:
at least one nacelle according to claim 6.
